(19) United States
(12) Patent Application Publication
(10) Pub. No.: US 2005/0140304 A1
(43) Pub. Date: Jun. 30, 2005

(54) Organic electroluminescent device and driving circuit thereof

(75) Inventors: Hung Jung Chang, Hsin Chu Industrial Park (TW); Peir-Jy Hu, Hsin Chu Industrial Park (TW)

Correspondence Address: BIRCH STEWART KOLASCH & BIRCH, PO BOX 747, FALLS CHURCH, VA, 22040-0747, US

(73) Assignee: RiTdisplay Corporation

(21) Appl. No.: 11/007,196

(22) Filed: Dec. 9, 2004

(30) Foreign Application Priority Data
Dec. 31, 2003 (TW) 092137854

(51) Int. Cl. G09G 3/10

(52) U.S. Cl. 315/169.3; 315/169.1

(57) ABSTRACT

An organic electroluminescent device comprises M scan lines, N data lines, a plurality of organic light-emitting units and a plurality of light driving units. The light driving unit drives the organic light-emitting unit. The light driving unit comprises a first transistor, a second transistor and a capacitance unit. The first transistor comprises a first gate, a first electrode and a second electrode. The first gate connects with the (M−j+1)^{th} scan line. The first electrode connects with the i^{th} data line. The second transistor comprises a second gate, a third electrode and a fourth electrode. The second gate connects with the second electrode. The third electrode connects with the (M−j)^{th} scan line, The fourth electrode connects with the organic light-emitting unit which is driven by the light driving unit. The capacitance unit has a first terminal and a second terminal. The first terminal connects with the (M−j)^{th} scan line. The second terminal connects with the second electrode and the second gate.

### CROSS REFERENCE TO RELATED APPLICATIONS

This Non-provisional application claims priority under 35 U.S.C. § 119(a) on patent application Ser. No(s). 09/213,7854 filed in Taiwan, Republic of China on Dec. 31, 2003, the entire contents of which are hereby incorporated by reference.

### BACKGROUND OF THE INVENTION

1. Field of Invention

The invention relates to a flat display device and a driving circuit thereof and, in particular, to an organic electroluminescent (OEL) device and a driving circuit thereof.

2. Related Art

Technology and type of the display device become diversified day by day as the application scope is widely extended and the transmitted information is increased. The display device began as displaying monochromic pictures, and then is capable of displaying color images and three-dimensional images. It also began as a CRT (cathode ray tube) device, is then a flat display device, and is developed towards a portable, foldable and large-screen display device. Regarding to the progress of the display device, the goals of the relative research are to provide a display device, which is more humanized and more convenient for users.

In view of the flat display devices, they generally include LCD (liquid crystal display) devices or organic electroluminescent devices. No matter which display device is concerned, the driving circuit for driving a pixel is necessary. As shown in FIG. 1, the driving circuit of a conventional electroluminescent device comprises a plurality of scan lines 11 (Yⱼ, Yⱼ₊₁, . . . ), a plurality of data lines 12 (Xᵢ, Xᵢ₊₁, . . . ), a plurality of organic light-emitting units 13, a plurality of light driving units 14 and a plurality of power lines 15.

The light driving unit 14 comprises a first transistor 141, a second transistor 142 and a capacitor 143. The first transistor 141 includes a gate 1411, a first electrode 1412 and a second electrode 1413. The gate 1411 of the first transistor 141 connects with the j^{th} scan line, the first electrode 1412 connects with the i^{th} data line, and the second electrode 1413 connects with one terminal of the capacitor 143. The other terminal of the capacitor 143 connects with one power line 15. The second transistor 142 includes a gate 1421, a third electrode 1422 and a fourth electrode 1423. The gate 1421 of the second transistor 142 connects with the second electrode 1413 and one terminal of the capacitor 143. The third electrode 1422 connects with one organic light-emitting unit 13, and the fourth electrode 1423 connects with the power line 15.

As mentioned above, regarding to the driving circuit of the conventional organic electroluminescent device, the voltage or current signals output from the data line 12 are provided from the power line 15 having the same direction as that of the data line 12. In other words, the voltage or current signals output from the data line 12 must follow through the power line 15. Concerning the organic light-emitting unit 13, since the voltage or current signals output from the data lines 12 have different path lengths, the resistance thereof are different, which results in the different voltages or currents following into the organic light-emitting unit 13. Thus, the brightness of the organic light-emitting units 13 is not uniform. Besides, the aperture ratio of the light-emitting area (regarding to the organic light-emitting unit 13) becomes smaller since the driving circuit of the conventional organic electroluminescent device includes a plurality of power lines 15, which must be disposed above the organic electroluminescent panel. As a result, the display effect thereof is poor.

It is therefore an important subjective of the invention to uniform the brightness of the organic light-emitting unit and to enlarge the aperture ratio of the light-emitting area of the organic light-emitting unit.

### SUMMARY OF THE INVENTION

In view of the foregoing, the invention is to provide an organic electroluminescent device, which has organic light-emitting units with uniform brightness and light-emitting area with enlarged aperture ratio, and driving circuit thereof.

To achieve the above, an organic electroluminescent device of the invention comprises M scan lines, N data lines, a plurality of organic light-emitting units and a plurality of light driving units. The light driving units drive the organic light-emitting units, respectively. The light driving unit comprises a first transistor, a second transistor and a capacitance unit. The first transistor comprises a first gate, a first electrode and a second electrode. The first gate connects with the (M−j+1)^{th} scan line. The first electrode connects with the i^{th} data line. Wherein, i is equal to or smaller than N and is equal to or greater than 1, j is smaller than M and is equal to or greater than 1, and M, N, i and j are all positive integrals. The second transistor comprises a second gate, a third electrode and a fourth electrode. The second gate connects with the second electrode of the first transistor, the third electrode connects with the (M−j)^{th} scan line, and the fourth electrode connects with the organic light-emitting unit driven by the light driving unit. The capacitance unit has a first terminal and a second terminal, wherein the first terminal connects with the (M−j)^{th} scan line and the second terminal connects with the second electrode and the second gate.

In addition, a driving circuit of the organic electroluminescent device of the invention comprises a plurality of light driving units, which drive the organic light-emitting units. The light driving unit comprises a first transistor, a second transistor and a capacitance unit. The first transistor comprises a first gate, a first electrode and a second electrode. The first gate connects with the (M−j+1)^{th} scan line. The first electrode connects with the i^{th} data line. Wherein, i is equal to or smaller than N and is equal to or greater than 1, j is smaller than M and is equal to or greater than 1, and M, N, i and j are all positive integrals. The second transistor comprises a second gate, a third electrode and a fourth electrode. The second gate connects with the second electrode of the first transistor, the third electrode connects with the (M−j)^{th} scan line, and the fourth electrode connects with the organic light-emitting unit driven by the light driving unit. The capacitance unit has a first terminal and a second terminal, wherein the first terminal connects with the (M−j)^{th} scan line and the second terminal connects with the second electrode and the second gate.

### BRIEF DESCRIPTION OF THE DRAWINGS

The invention will become more fully understood from the detailed description given herein below illustration only, and thus is not limitative of the present invention, and wherein:

FIG. 1 is a schematic view showing the driving circuit of the conventional organic electroluminescent device;

FIG. 2 is a schematic view showing a driving circuit of an organic electroluminescent device according to a preferred embodiment of the invention;

FIG. 3A is a timing chart showing a voltage signal inputted into each data line shown in FIG. 2;

FIG. 3B is a timing chart showing a voltage signal inputted into each scan line shown in FIG. 2;

FIG. 4 is a schematic view showing a driving circuit of an organic electroluminescent device according to another preferred embodiment of the invention;

FIG. 5A is a timing chart showing a voltage signal inputted into each data line shown in FIG. 4; and

FIG. 5B is a timing chart showing a voltage signal inputted into each scan line shown in FIG. 4.

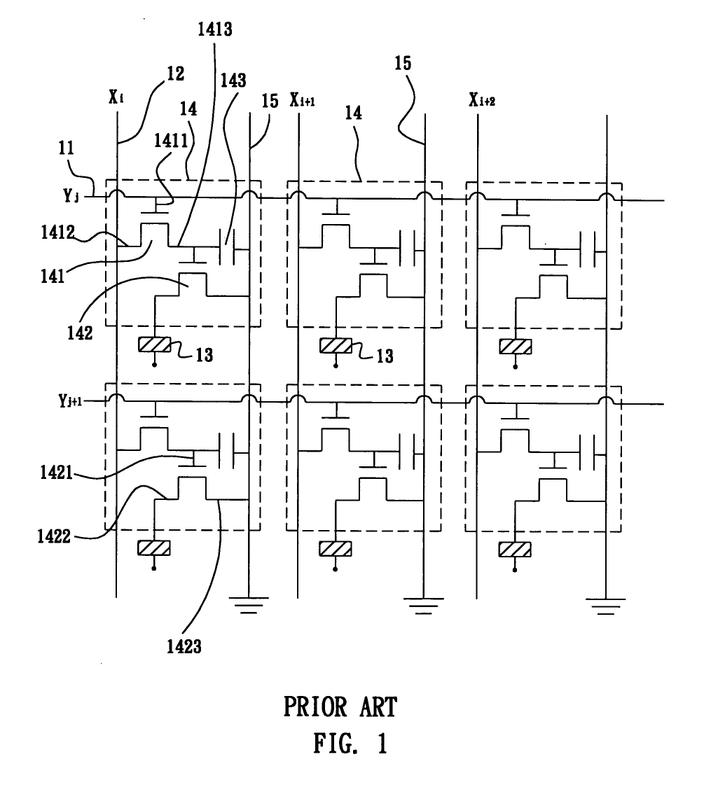

### DETAILED DESCRIPTION OF THE INVENTION

The present invention will be apparent from the following detailed description, which proceeds with reference to the accompanying drawings, wherein the same references relate to the same elements.

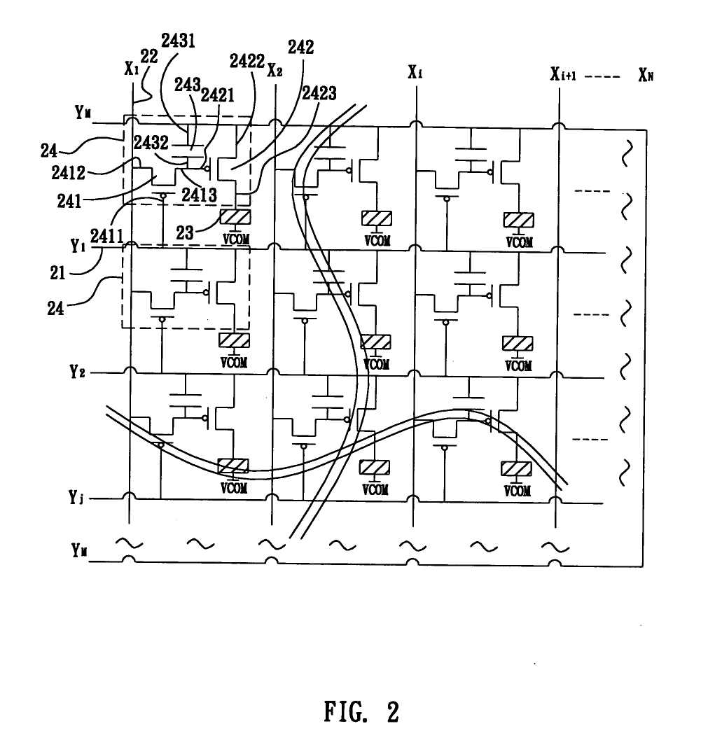

With reference to FIG. 2, an organic electroluminescent device of the invention comprises M scan lines 21, N data lines 22, a plurality of organic light-emitting units 23 and a plurality of light driving units 24. In the embodiment, the scan lines 21, the data lines 22, the organic light-emitting units 23 and the light driving units 24 can be disposed above a substrate (not shown).

The light driving units 24 drive the organic light-emitting units 23. The light driving unit 24 comprises a first transistor 241, a second transistor 242 and a capacitance unit 243. The first transistor 241 comprises a first gate 2411, a first electrode 2412 and a second electrode 2413. The first gate 2411 connects with the (M−j+1)^{th} scan line 21. The first electrode 2412 connects with the i^{th} data line 22. Wherein, i is equal to or smaller than N and is equal to or greater than 1, j is smaller than M and is equal to or greater than 1, and N, M, i and j are all positive integrals. The second transistor 242 comprises a second gate 2421, a third electrode 2422 and a fourth electrode 2423. The second gate 2421 connects with the second electrode 2413 of the first transistor 241, the third electrode 2422 connects with the (M−j)^{th} scan line 21, and the fourth electrode 2423 connects with the organic light-emitting unit 23 driven by the light driving unit 24. The capacitance unit 243 has a first terminal 2431 and a second terminal 2432. In this case, the first terminal 2431 connects with the (M−j)^{th} scan line 21 and the second terminal 2432 connects with the second electrode 2413 and the second gate 2421.

To be noted, in the present embodiment, when j is equal to M, the third electrode 2422 connects with the M^{th} scan line Y_{M}, and the first gate 2411 connects with the first scan line Y₁. In other words, the last and first scan lines are correspondingly utilized for driving the transistor.

Referring to FIG. 2, the light driving units 24 drive the organic light-emitting units 23. The light driving unit 24 comprises a first transistor 241, a second transistor 242 and a capacitance unit 243. In this embodiment, the first transistor 241 comprises a first gate 2411, a first electrode 2412 and a second electrode 2413. The first gate 2411 connects with the second scan line Y₂. The first electrode 2412 connects with the first data line 22. The second transistor 242 comprises a second gate 2421, a third electrode 2422 and a fourth electrode 2423. The second gate 2421 connects with the second electrode 2413 of the first transistor 241, the third electrode 2422 connects with the first scan line Y₁, and the fourth electrode 2423 connects with the organic light-emitting unit 23 driven by the light driving unit 24. The capacitance unit 243 has a first terminal 2431 and a second terminal 2432. In this case, the first terminal 2431 connects with the first scan line Y₁ and the second terminal 2432 connects with the second electrode 2413 and the second gate 2421.

In the current embodiment, the first transistor 241 and the second transistor 242 are a PMOS arrangement. Accordingly, the first electrode 2412 and the second electrode 2413 are the source and drain of the first transistor 241, and the third electrode 2422 and the fourth electrode 2423 are the source and drain of the second transistor 242. The capacitance unit 243 is a capacitor.

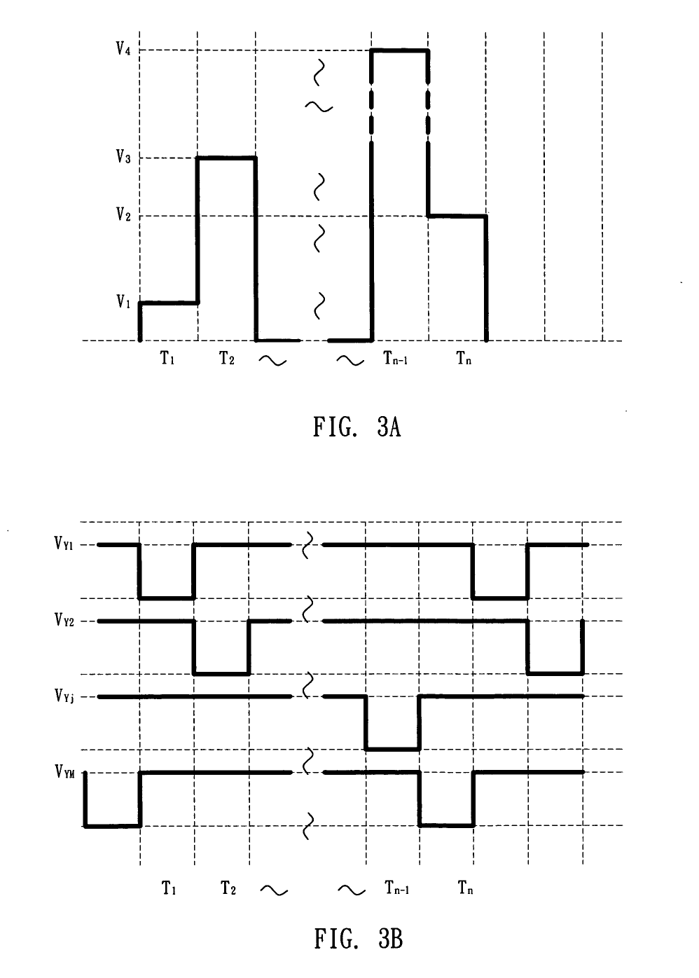

Hereinafter, the actual driving process of the organic electroluminescent device of the invention is described with reference to FIGS. 3A and 3B.

When the voltage signal V_{Y1} as shown in FIG. 3B is inputted into the first scan line Y₁ as shown in FIG. 2, the first scan line Y₁ is charged with a negative bias signal during a period T₁. Accordingly, the first gate 2411 of the first transistor 241 is ON, and the voltage signals V₁, V₂, V₃, etc., as well as current signals, loaded on the i^{th} data line Xᵢ can be written into the capacitance unit 243 through the first transistor 241. In addition, since the M^{th} scan line Y_{M} is at a positive bias state during the period T₁, the second transistor 242 is ON. Thus, the electricity stored in the capacitance unit 243 follows through the organic light-emitting unit 23 so as to drive the organic light-emitting unit 23. Of course, when the voltage signal V_{Y2} as shown in FIG. 3B is inputted into the second scan line Y₂ as shown in FIG. 2, the second scan line Y₂ is charged with a negative bias signal during a period T2. Therefore, the first gate 2411 of the first transistor 241 is ON, and the voltage signals V₁, V₂, V₃, etc., as well as current signals, loaded on the i^{th} data line Xᵢ can be written into the capacitance unit 243 through the first transistor 241.

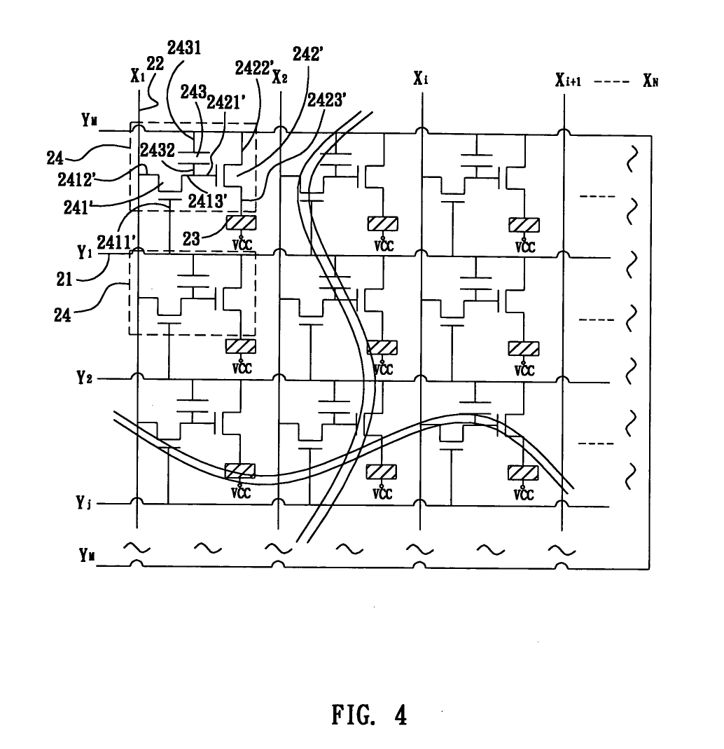

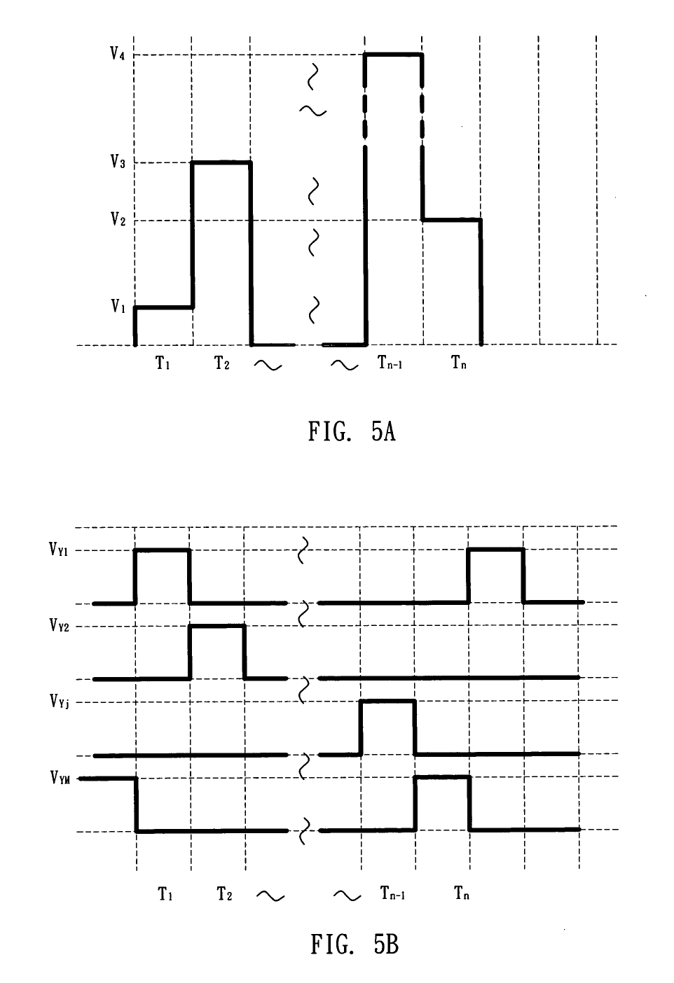

An organic electroluminescent device according to another embodiment of the invention will be described hereinafter with reference to FIGS. 4, 5A and 5B. In this embodiment, the same elements are described referring to the same references mentioned above, and the first transistor 241′ and the second transistor 242′ are a NMOS arrangement.

The light driving units 24 drive the organic light-emitting units 23. The light driving unit 24 comprises a first transistor 241′, a second transistor 242′ and a capacitance unit 243. The first transistor 241′ comprises a first gate 2411′, a first electrode 2412′ and a second electrode 2413′. The first gate 2411′ connects with the (M−j+1)^{th} scan line 21. The first electrode 2412′ connects with the i^{th} data line 22. Wherein, i is equal to or smaller than N and is equal to or greater than 1, j is smaller than M and is equal to or greater than 1, and M, N, i and j are all positive integrals. The second transistor 242′ comprises a second gate 2421′, a third electrode 2422′ and a fourth electrode 2423′. The second gate 2421′ connects with the second electrode 2413′ of the first transistor 241′, the third electrode 2422′ connects with the (M−j)^{th} scan line 21, and the fourth electrode 2423′ connects with the organic light-emitting unit 23 driven by the light driving unit 24. The capacitance unit 243 has a first terminal 2431 and a second terminal 2432. Herein, the first terminal 2431 connects with the (M−j)^{th} scan line 21 and the second terminal 2432 connects with the second electrode 2413 and the second gate 2421.

With reference to FIG. 4, the light driving units 24 drive the organic light-emitting units 23. The light driving unit 24 comprises a first transistor 241′, a second transistor 242′ and a capacitance unit 243′. In this embodiment, the first transistor 241′ comprises a first gate 2411′, a first electrode 2412′ and a second electrode 2413′. When j is equal to M, the third electrode 2422′ connects with the M^{th} scan line Y_{M}, and the first gate 2411′ connects with the first scan line Y₁. In other words, the last and first scan lines are correspondingly utilized for driving the transistor. The first gate 2411′ connects with the second scan line Y₂. The first electrode 2412′ connects with the first data line 22. The second transistor 242′ comprises a second gate 2421′, a third electrode 2422′ and a fourth electrode 2423′. The second gate 2421′ connects with the second electrode 2413′ of the first transistor 241′, the third electrode 2422′ connects with the first scan line Y₁, and the fourth electrode 2423′ connects with the organic light-emitting unit 23 driven by the light driving unit 24. The capacitance unit 243 has a first terminal 2431 and a second terminal 2432. In this case, the first terminal 2431 connects with the first scan line Y₁ and the second terminal 2432 connects with the second electrode 2413′ and the second gate 2421′.

Hereinafter, the actual driving process of the organic electroluminescent device of the invention is described with reference to FIGS. 5A and 5B.

When the voltage signal V_{Y1} as shown in FIG. 5B is inputted into the first scan line Y₁ as shown in FIG. 4, the first scan line Y₁ is charged with a positive bias signal during a period T₁. Accordingly, the first gate 2411′ of the first transistor 241′ is ON, and the voltage signals V₁, V₂, V₃, etc., as well as current signals, loaded on the i^{th} data line Xᵢ can be written into the capacitance unit 243 through the first transistor 241′. In addition, since the M^{th} scan line Y_{M} is at a negative bias state during the period T₁, the second transistor 242′ is ON. Thus, the electricity stored in the capacitance unit 243 follows through the organic light-emitting unit 23 so as to drive the organic light-emitting unit 23.

The driving circuit of the organic electroluminescent device of this embodiment is similar to the driving circuit described in the previous embodiment, so the detailed descriptions are omitted for concise purpose.

Briefly described, the conventional power lines are not disposed in the organic electroluminescent device and driving circuit of the invention, and the driving unit is provided with the voltage or current source from the two scan lines, including the previous one and next one. Thus, the paths through which the voltage or current signals pass can have the same resistance. Accordingly, the brightness of the organic light-emitting unit is uniform. In addition, since the conventional power lines are not disposed in the organic electroluminescent device and driving circuit of the invention, regarding to the organic light-emitting unit, the aperture ratio of the light-emitting area is enlarged, resulting in the increase of display effect.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A driving circuit of an organic electroluminescent device, the organic electroluminescent device comprising M scan lines, N data lines and a plurality of organic light-emitting units, the driving circuit comprising a plurality of light driving units for driving the organic light-emitting units, wherein the light driving unit comprises:
a first transistor, which comprises a first gate, a first electrode and a second electrode, wherein the first gate connects with the (M−j+1)^{th} scan line of the M scan lines, the first electrode connects with the i^{th} data line of the N data lines, i is equal to or smaller than N and is equal to or greater than 1, j is smaller than M and is equal to or greater than 1, and M, N, i and j are all positive integrals;
a second transistor, which comprises a second gate, a third electrode and a fourth electrode, wherein the second gate connects with the second electrode of the first transistor, the third electrode connects with the (M−j)^{th} scan line of the M scan lines, the fourth electrode connects with the organic light-emitting unit driven by the light driving unit; and
a capacitance unit, which has a first terminal and a second terminal, wherein the first terminal connects with the (M−j)^{th} scan line of the M scan lines, and the second terminal connects with the second electrode and the second gate.

2. The driving circuit of claim 1, wherein the first gate connects with the first scan line of the M scan lines when the third electrode connects with the M^{th} scan line of the M scan lines.

3. The driving circuit of claim 1, wherein the first transistor is a thin film transistor.

4. The driving circuit of claim 1, wherein the second transistor is a thin film transistor.

5. The driving circuit of claim 1, wherein the first transistor is an NMOS arrangement.

6. The driving circuit of claim 5, wherein the first electrode and the second electrode are a source electrode and a drain electrode, respectively.

7. The driving circuit of claim 1, wherein the first transistor is a PMOS arrangement.

8. The driving circuit of claim 7, wherein the third electrode and the fourth electrode are a source electrode and a drain electrode, respectively.

9. The driving circuit of claim 1, wherein the capacitance unit is a capacitor.

10. An organic electroluminescent device, comprising:
M scan lines;
N data lines;
a plurality of organic light-emitting units; and
a plurality of light driving units, which drive the organic light-emitting units, wherein the light driving unit comprises a first transistor, a second transistor and a capacitance unit, the first transistor comprises a first gate, a first electrode and a second electrode, the first gate connects with the (M−j+1)^{th} scan line of the M scan lines, the first electrode connects with the i^{th} data line of the N data lines, i is equal to or smaller than N and is equal to or greater than 1, j is smaller than M and is equal to or greater than 1, and M, N, i and j are all positive integrals, the second transistor comprises a second gate, a third electrode and a fourth electrode, the second gate connects with the second electrode of the first transistor, the third electrode connects with the (M−j)^{th} scan line of the M scan lines, the fourth electrode connects with the organic light-emitting unit driven by the light driving unit, the capacitance unit has a first terminal and a second terminal, the first terminal connects with the (M−j)^{th} scan line of the M scan lines, and the second terminal connects with the second electrode and the second gate.

11. The organic electroluminescent device of claim 10, wherein the first gate connects with the first scan line of the M scan lines when the third electrode connects with the M^{th} scan line of the M scan lines.

12. The organic electroluminescent device of claim 10, wherein the first transistor is a thin film transistor.

13. The organic electroluminescent device of claim 10, wherein the second transistor is a thin film transistor.

14. The organic electroluminescent device of claim 10, wherein the first transistor is an NMOS arrangement.

15. The organic electroluminescent device of claim 14, wherein the first electrode and the second electrode are a source electrode and a drain electrode, respectively.

16. The organic electroluminescent device of claim 10, wherein the first transistor is a PMOS arrangement.

17. The organic electroluminescent device of claim 16, wherein the third electrode and the fourth electrode are a source electrode and a drain electrode, respectively.

18. The organic electroluminescent device of claim 10, wherein the capacitance unit is a capacitor.
